(19) United States
(12) Patent Application Publication
(10) Pub. No.: US 2016/0129576 A1
(43) Pub. Date: May 12, 2016

(54) IMPACT TOOL

(71) Applicant: HITACHI KOKI CO., LTD., Hitachinaka-City (JP)

(72) Inventors: Tomomasa Nishikawa, Hitachinaka-City (JP); Nobuhiro Takano, Hitachinaka-City (JP); Shinichirou Satou, Hitachinaka-City (JP)

(21) Appl. No.: 14/893,768

(22) PCT Filed: Apr. 25, 2014
(86) PCT No.: PCT/JP2014/061700

§ 371 Date: Nov. 24, 2015

(30) Foreign Application Priority Data
May 31, 2013 (JP) 2013-114823

(51) Int. Cl. B25D 11/00; B25D 17/11

(52) U.S. Cl. CPC B25D 11/00; B25D 17/11

(57) ABSTRACT

An impact tool capable of improving durability of tool components and capable of reducing noise and vibration is provided. The impact tool includes a housing, a motor, a motion converting portion, an output portion, a power supply portion, a load detecting portion, and a control portion. The motor is disposed in the housing. The motion converting portion is configured to convert a rotating motion of the motor into a reciprocating motion. The output portion is configured to output the reciprocating motion of the motion converting portion as an impact force. The power supply portion is configured to supply a driving power to the motor. The load detecting portion is configured to detect a load imposed on the motor. The control portion is configured to control the power supply portion to increase the driving power supplied to the motor during a prescribed period when the load detected by the load detecting portion is larger than a prescribed value.

### TECHNICAL FIELD

The invention relates to an impact tool.

### BACKGROUND ART

A conventional impact tool is provided with a motor, a motion converting mechanism configured to convert a rotating motion of the motor into a reciprocating motion, a piston configured to be reciprocally moved by the motion converting mechanism, an impact member configured to be reciprocally moved in interlocking relation to a reciprocating motion of the piston, an intermediate member configured to be impacted by the impact member, and an output portion configured to output an impact force (for example, see Patent Literature 1).

### CITATION LIST

### Patent Literature

PTL 1: Japanese Patent Application Publication No. 2012-139752

### SUMMARY OF INVENTION

### Technical Problem

In the impact tool, both enhanced impact force and downsizing of the impact tool are required. In case where the above two requirements in the conventional impact tool is to be fulfilled, excessive force is applied to components of such as the motion converting mechanism due to increased impact force and due to reduced size of mechanical components of the motion converting mechanism for the purpose of downsizing of the impact tool, thereby reducing service life of the impact tool. Further, in the conventional impact tool, vibration and noise become more remarkable in conjunction with increased impact force.

In view of the foregoing, it is an object of the invention to provide an impact tool capable of improving durability of tool components and capable of reducing noise and vibration.

### Solution to Problem

In order to attain above and other object, the present invention provides an impact tool. The impact tool includes a housing, a motor, a motion converting portion, an output portion, a power supply portion, a load detecting portion, and a control portion. The motor is disposed in the housing. The motion converting portion is configured to convert a rotating motion of the motor into a reciprocating motion. The output portion is configured to output the reciprocating motion of the motion converting portion as an impact force. The power supply portion is configured to supply a driving power to the motor. The load detecting portion is configured to detect a load imposed on the motor. The control portion is configured to control the power supply portion to increase the driving power supplied to the motor during a prescribed period when the load detected by the load detecting portion is larger than a prescribed value.

According to the above configuration, constant supply of the large driving power is not required. Instead, the large driving power is supplied only in case of large load application to the impact tool. Thus, the number of times of the impacting action with large impact force can be reduced. Therefore, durability of mechanical parts, those being components of the motion converting portion and the output portion, can be improved. Further, in a state where low load is imparted, noise and vibration can be reduced because the impact force is small. Particularly in a no-load state, remarkable reduction effect in vibration and noise can be obtained.

Preferably, the prescribed period is a time period during which at least a single impacting action is performed.

Preferably, the control portion is configured to restore the driving power supplied to the motor to an ordinary driving power after increasing the driving power supplied to the motor for the prescribed period.

In this configuration, large impact force can be obtained only when needed. Thus, the number of times of the impacting action with large impact force can be reduced. Consequently, durability of mechanical parts, those being components of the motion converting portion and the output portion, can be improved.

Preferably, the power supply portion includes an inverter circuit board. The control portion is configured to increase the driving power by increasing a duty ratio of a PWM outputted to the inverter circuit board.

By the above configuration, the driving power can be increased by increasing the duty ratio of the PWM outputted from the control portion to the inverter circuit board.

Preferably, the load detecting portion includes a current detecting portion configured to detect a current flowing through the motor. The control portion is configured to control the power supply portion to increase the driving power supplied to the motor during the prescribed period when the current detected by the current detecting portion is greater than a current threshold level.

In the above configuration, detection of the load can be performed on the basis of the current flowing through the motor. Therefore, the driving power can be adjusted in response to the load. Consequently, prolonged service life of the parts and components employed in the impact tool can be obtained, and reduction in vibration and noise can be realized.

Preferably, the load detecting portion includes a rotational number detecting portion configured to detect a rotational number of the motor. The control portion is configured to control the power supply portion to increase the driving power supplied to the motor during the prescribed period when the rotational number detected by the rotational number detecting portion is not more than a rotational number threshold level.

In this configuration, detection of the load can be performed on the basis of the rotational number of the motor. Therefore, the driving power can be adjusted in response to the load. Consequently, prolonged service life of the parts and components employed in the impact tool can be obtained, and reduction in vibration and noise can be realized.

Preferably, the load detecting portion includes a sound pressure detecting portion configured to detect a sound pressure. The control portion is configured to control the power supply portion to increase the driving power supplied to the motor during the prescribed period when the sound pressure detected by the sound pressure detecting portion is higher than a sound pressure threshold level.

By this configuration, detection of the load can be performed on the basis of the sound pressure at the time of impacting. Therefore, the driving power can be adjusted in response to the load. Consequently, prolonged service life of the parts and components employed in the impact tool can be obtained, and reduction in vibration and noise can be realized.

Preferably, the control portion is configured to control the power supply portion to increase the driving power supplied to the motor while the load detected by the load detecting portion exceeds the prescribed value.

In the above configuration, driving power greater than ordinary driving power is supplied while large load is imposed on the motor. Thus, large impact force can be obtained. Consequently, ensured crushing of stones and some other workpiece requiring higher impact force can be realized.

Preferably, the control portion is configured to control the power supply portion to further increase the driving power supplied to the motor when the load detected by the load detecting portion further exceeds a threshold value larger than the prescribed value after the load exceeds the prescribed value.

With this configuration, the driving power can be changed in stepwise fashion on the basis of the load. Thus, appropriate impact force can be obtained in response to fluctuation of the load. Consequently, prolonged service life of the parts and components employed in the impact tool can be obtained. Further, reduction in vibration and noise can be realized, and energy saving can be achieved.

Preferably, the control portion is configured to perform a low-speed control immediately after start-up period of the motor, and to perform a high-speed control in response to the load detected by the load detecting portion.

In this configuration, positioning of the crushing point can be facilitated because the low-speed control for driving the motor can be performed after start-up period thereof. Therefore, the operability of the impact tool can be improved, and thus enhanced work efficiency can be obtained.

### Advantageous Effects of Invention

The invention provides an impact tool capable of improving durability of tool components and capable of reducing noise and vibration.

### BRIEF DESCRIPTION OF DRAWINGS

FIG. 1 is a cross-sectional view of a hammer according to a first embodiment of the present invention.

FIG. 2 is a control block diagram of the hammer according to the first embodiment of the present invention.

FIG. 3 is a schematic indicating a state of a workpiece being crushed by the hammer according to the first embodiment of the present invention.

FIG. 4 is a flowchart of the hammer according to the first embodiment of the present invention.

FIG. 5 is a graph indicating various parameters of the hammer according to the first embodiment of the present invention and further indicating various parameters of a hammer according to a second embodiment of the present invention.

FIG. 6 is a flowchart of the hammer according to the second embodiment of the present invention.

FIG. 7 is a schematic indicating a state of a workpiece being drilled by a hammer drill according to a third embodiment of the present invention.

FIG. 8 is a graph indicating various parameters of the hammer drill according to the third embodiment of the present invention.

FIG. 9 is a flowchart of the hammer drill according to the third embodiment of the present invention.

FIG. 10 is a cross-sectional view of a hammer according to a fourth embodiment of the present invention.

FIG. 11 is a control block diagram of the hammer according to the fourth embodiment of the present invention.

FIG. 12 is a flowchart of the hammer according to the fourth embodiment of the present invention.

FIG. 13 is a graph indicating various parameters of a hammer drill according to one modification of the embodiments of the present invention.

### DESCRIPTION OF EMBODIMENTS

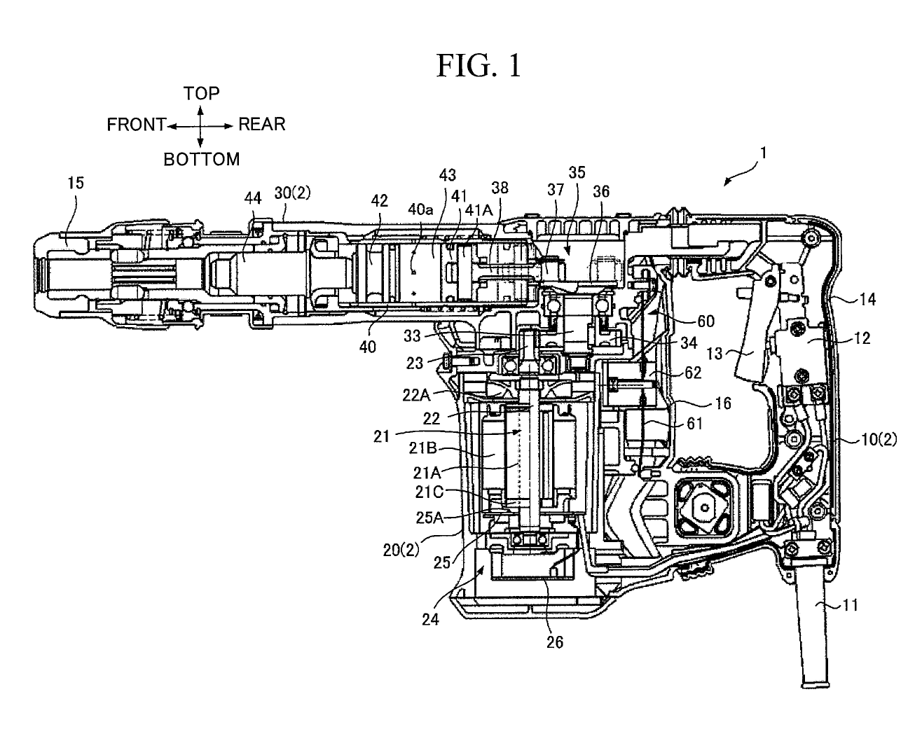

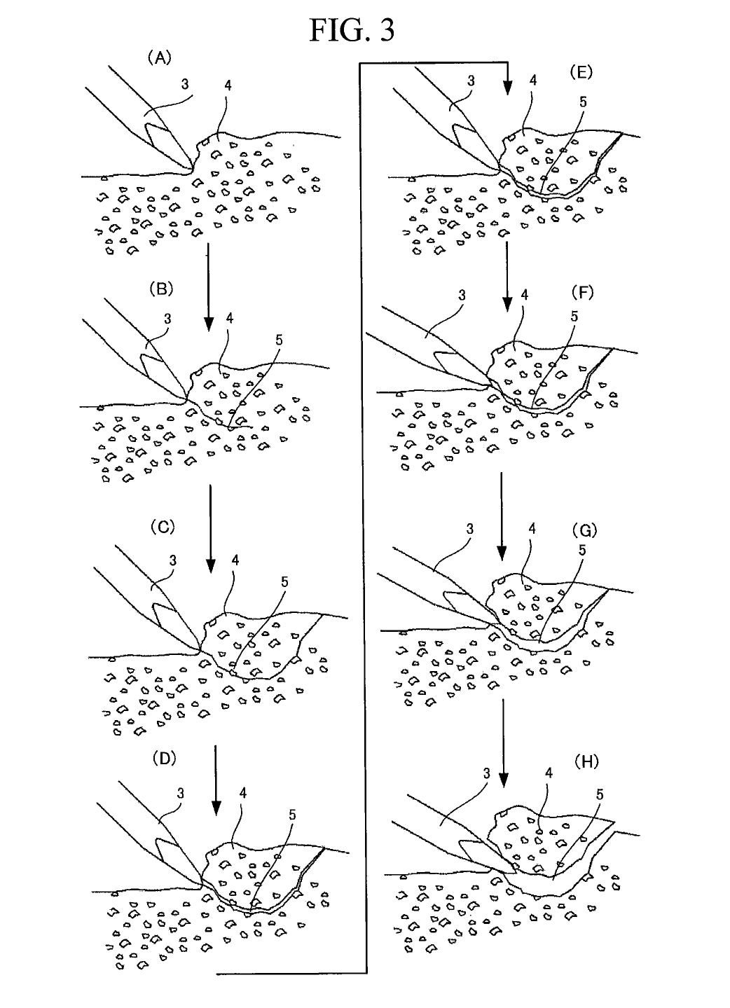

An impact tool according to one embodiment of the present invention will be described with reference to FIG. 1. FIG. 1 is a cross-sectional view illustrating a hammer 1 which is representative of the impact tool. The hammer 1 is provided with a housing 2 including a handle portion 10, a motor housing 20, and an outer frame 30. The outer frame 30 has one end portion opposite to the handle portion 10, and a bit holding portion 15 is disposed at the one end portion of the outer frame 30. The bit holding portion 15 is capable of detachably holding an end bit 3 illustrated in FIG. 3. In the following description, a direction from the handle portion 10 to the bit holding portion 15 will be referred to as “frontward direction”, and a direction opposite thereto will be referred to as “rearward direction.” Further, a direction in which the motor housing 20 extends from the outer frame 30 will be referred to as “downward direction”, and a direction opposite thereto will be referred to as “upward direction.” Further, “rightward direction” and “leftward direction” will be used when viewing the hammer 1 from a rear side thereof in FIG. 1.

The handle portion 10 is equipped with a power cable 11 and accommodates a switch mechanism 12. The switch mechanism 12 is mechanically connected to a trigger 13 capable of being manipulated by a user. The power cable 11 is adapted to connect the switch mechanism 12 to an external power source (not illustrated). An electrical connection and a disconnection between a brushless motor 21 (described later) and the external power source can be switched by manipulation of the trigger 13. The handle portion 10 includes a grasped portion 14 and a connection portion 16. The grasped portion 14 is grasped by the user while the hammer 1 is used. The connection portion 16 is connected to the motor housing 20 and the outer frame 30 for covering both the motor housing 20 and the outer frame 30 from rearward. The power cable 11 is an example of claimed “a power supply portion” of the present invention.

The motor housing 20 is provided at frontward lower side of the handle portion 10. The handle portion 10 and the motor housing 20 are separately constructed. However, the handle portion 10 and the motor housing 20 may be formed of plastics by integral molding.

The brushless motor 21 is accommodated in the motor housing 20. The brushless motor 21 includes a rotor 21A, a stator 21B and an output shaft 22 outputting a rotational driving force. The rotor 21A has a lower end portion provided with a magnet 21C used for sensing. The output shaft 22 has a tip end provided with a pinion gear 23 positioned in an inner space of the outer frame 30. A fan 22A is disposed downward of the pinion gear 23 and coaxially fixed to the output shaft 22. A control portion 24 for controlling a rotational speed of the brushless motor 21 is disposed in an inner space of the motor housing 20 and at a position downward of the brushless motor 21.

The control portion 24 includes an inverter circuit board 25 and a control board 26, the inverter circuit board 25 has rotational position detecting elements 25A. Details of the control portion 24 will be described later.

In the inner space of the outer frame 30, a crank shaft 33 is positioned rearward of the pinion gear 23 and is rotatably supported. The crank shaft 33 extends in parallel to the output shaft 22. The crank shaft 33 has a lower end to which a first gear 34 is coaxially fixed. The first gear 34 is meshingly engaged with the pinion gear 23. The crank shaft has an upper end portion provided with a motion converting mechanism 35. The motion converting mechanism 35 includes a crank weight 36, a crank pin 37, and a connection-rod 38. The crank weight 36 is fixed to the upper end portion of the crank shaft 33. The crank pin 37 is fixed to an end portion of the crank weight 36. The crank pin 37 is inserted into a rear end portion of the connection-rod 38. The crank shaft 33, the crank weight 36, and the crank pin 37 are integrally constructed by machining. However, some of the components, for example, the crank pin 37 may be processed separately from the others and then assembled with the others.

A cylinder 40 is disposed in the inner space of the outer frame 30 and extends in a direction (frontward/rearward direction) orthogonal to an extending direction of the output shaft 22. The cylinder 40 is formed with a plurality of breathing holes 40a arrayed in a circumferential direction of the cylinder 40. A center axis of the cylinder 40 and a rotational axis of the output shaft 22 are positioned on a same plane. The cylinder 40 has a rear end portion in confrontation with the brushless motor 21 in upward/downward direction. A piston 41 is accommodated in the cylinder 40 and is slidably movable relative to an inner surface thereof in frontward/rearward direction. The piston 41 has a piston pin 41A inserted into a tip end portion of the connection-rod 38. An impact member 42 is disposed in a front end side of the inner space of the cylinder 40 and is reciprocally slidable relative to the inner surface thereof in frontward/rearward direction. Further, an air chamber 43 is defined between the piston 41 and the impact member 42 in the inner space of the cylinder 40.

The bit holding portion 15 is provided at a front portion of the outer frame 30 for detachably holding the end bit 3 (FIG. 3). An intermediate member 44 is disposed frontward of the impact member 42 and is movable in frontward/rearward direction. The bit holding portion 15 is an example of claimed “an output portion” of the present invention.

A counter weight mechanism 60 (a vibration reducing mechanism) is positioned in confrontation with the handle portion 10 and is provided at a position between the connection portion 16 and both of the outer frame 30 and the motor housing 20. The counter weight mechanism 60 includes a leaf spring 61 and a counter weight 62. Vibration generated due to reciprocating motion of the impact member 42 can be absorbed by vibration of the counter weight 62 supported to the leaf spring 61.

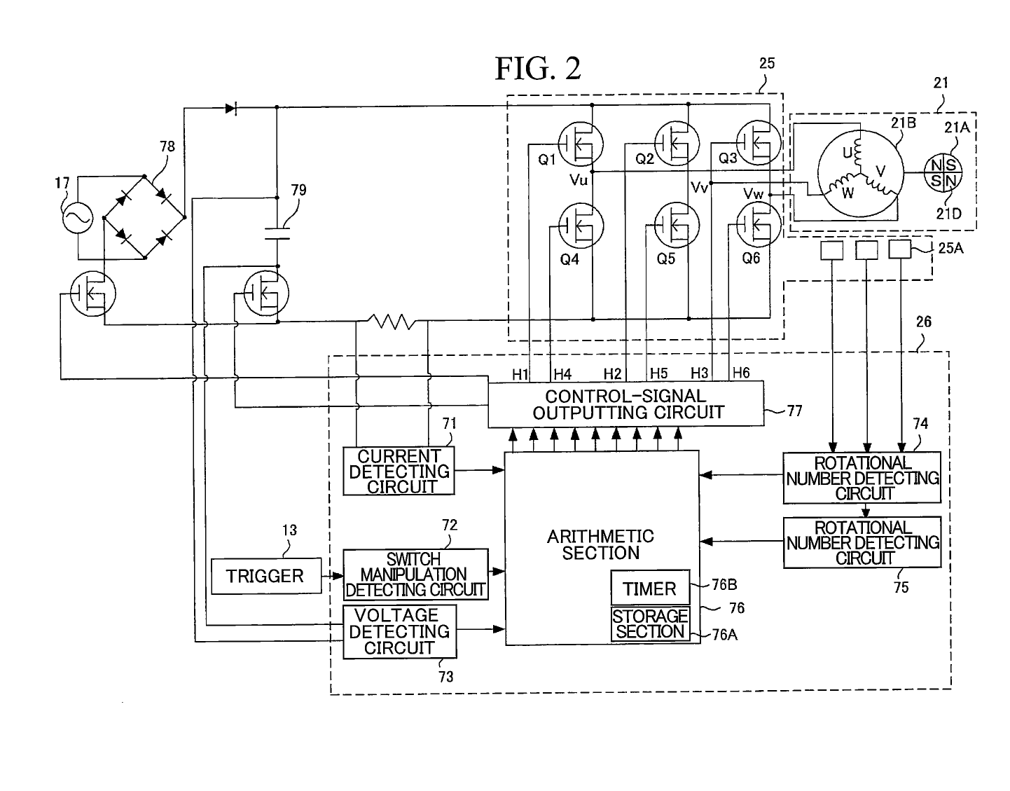

Next, the configuration of the control system for driving the brushless motor 21 will be described while referring to FIG. 2. In the present embodiment, the brushless motor 21 is a three-phase brushless DC motor. The rotor 21A has a permanent magnet 21D including a plurality of sets (two sets in the present embodiment) of N and S poles. The stator 21B has three-phase stator windings U, V, and W which are connected by star connection.

As illustrated in FIG. 2, the inverter circuit board 25 has the rotational position detecting elements 25A and six switching elements Q1-Q6 such as FET connected in the form of three-phase bridge connection. The rotational position detecting elements 25A are arranged at positions confronting the magnet 21C of the rotor 21A, and neighboring rotational position detecting elements 25A are spaced away from each other by a predetermined interval (for example, an angle of 60 degrees) in a circumferential direction of the rotor 21A.

The control board 26 is electrically connected to the inverter circuit board 25. The control board 26 has a current detecting circuit 71, a switch manipulation detecting circuit 72, a voltage detecting circuit 73, a rotational position detecting circuit 74, a rotational number detecting circuit 75, an arithmetic section 76, and a control-signal outputting circuit 77.

AC voltage supplied from an AC power source 17 via the power cable 11 is full-wave rectified by a bridge circuit 78 and smoothed by a smoothing capacitor 79, and then the resultant voltage is supplied to the inverter circuit board 25.

Each of the six switching elements Q1-Q6 on the inverter circuit board 25 has a gate connected to the control-signal outputting circuit 77 on the control board 26. The drain or source of each of the switching elements Q1-Q6 is connected to selected one of the stator windings U, V, and W of the stator 21B. The six switching elements Q1-Q6 perform switching actions in response to switching element driving signals inputted from the control-signal outputting circuit 77, so that three-phase (U-phase, V-phase, and W-phase) voltages Vu, Vv, and Vw are generated from the DC voltage applied to the inverter circuit board 25. The voltages Vu, Vv, and Vw are sequentially supplied to the stator windings U, V, and W as driving power. Specifically, a rotational direction of the rotor 21A, that is, the stator windings U, V, and W to be sequentially energized can be controlled by output switching signals H1-H3 inputted from the control-signal outputting circuit 77 to the positive-line side switching elements Q1-Q3. Amount of electric power supplied to the stator windings, that is, the rotational speed of the rotor 21A can be controlled by pulse width modulation signals (PWM signals) H4-H6 inputted from the control-signal outputting circuit 77 to the negative-line side switching elements Q4-Q6.

The current detecting circuit 71 is adapted to detect current supplied to the brushless motor 21, and to output the detected current to the arithmetic section 76. The voltage detecting circuit 73 is adapted to detect voltage applied to the inverter circuit board 25, and to output the detected voltage to the arithmetic section 76. The switch manipulation detecting circuit 72 is adapted to detect whether the trigger 13 is manipulated, and to output the detection result to the arithmetic section 76. The current detecting circuit 71 is an example of claimed “a load detecting portion” of the present invention, and is also an example of claimed “a current detecting portion” of the present invention.

The rotational position detecting circuit 74 is adapted to detect a rotational position of the rotor 21A on the basis of signals outputted from the rotational position detecting elements 25A, and to output the detected rotational position to both the arithmetic section 76 and the rotational number detecting circuit 75. The rotational number detecting circuit 75 is adapted to detect a rotational number of the rotor 21A on the basis of the signals outputted from the rotational position detecting elements 25A, and to output the detected rotational number to the arithmetic section 76. The rotational position detecting circuit 74 and the rotational number detecting circuit 75 are examples of claimed “a load detecting portion” of the present invention, and are also examples of claimed “a rotational number detecting portion” of the present invention. Note that, the rotational position detecting circuit 74 and the rotational number detecting circuit 75 may be integrally constructed as a single circuit. Further, some or all functions of the rotational position detecting circuit 74 and the rotational number detecting circuit 75 may be incorporated in the arithmetic section 76. Further, the rotational position detecting elements 25A may output the signals to the rotational number detecting circuit 75, so that the latter may detect the rotational number on the basis of the signals outputted from the rotational position detecting elements 25A.

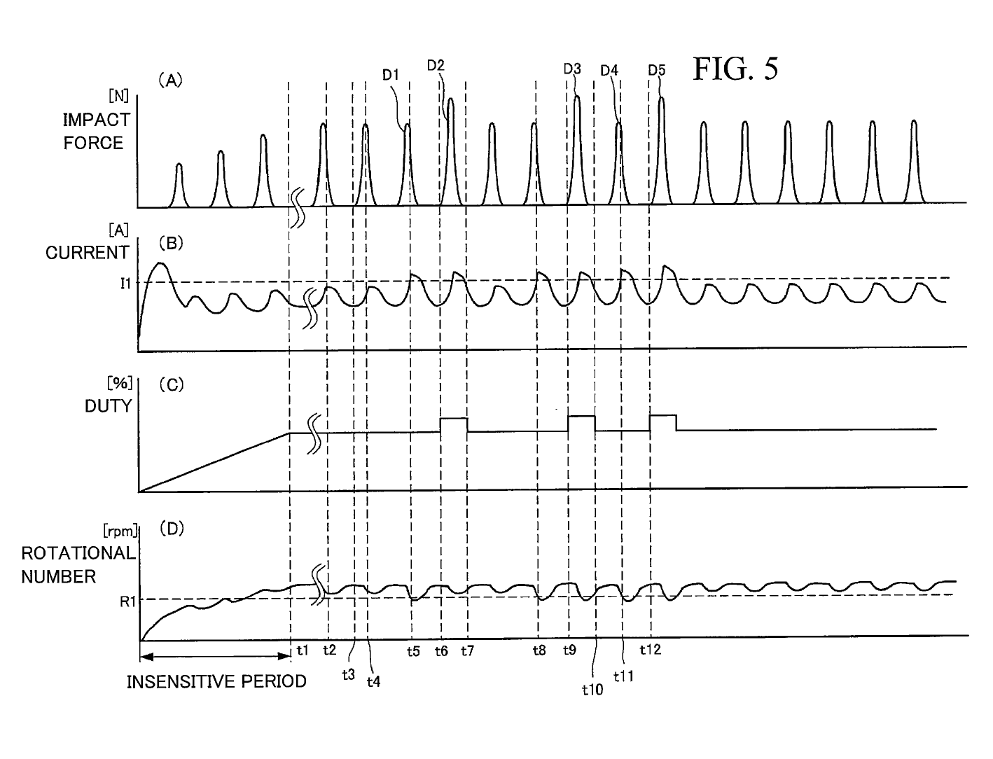

The arithmetic section 76 includes a central processing unit (CPU) not illustrated in Figure for outputting driving signals on the basis of both processing programs and data, a storage section 76A for storing the processing programs and control data, and a timer 76B for counting time. Specifically, the storage section 76A stores a current threshold value I1 as illustrated in FIG. 5 and some other various threshold values. The arithmetic section 76 is adapted to generate the output switching signals H1-H3 on the basis of the signals outputted from the rotational position detecting circuit 74 and the rotational number detecting circuit 75, and to output the generated signals to the control-signal outputting circuit 77. The arithmetic section 76 is further adapted to generate the pulse width modulation signals (PWM signals) H4-H6, and to output the PWM signals to the control-signal outputting circuit 77. Incidentally, the PWM signals may be outputted to the positive-line side switching elements Q1-Q3, and the output switching signals may be outputted to the negative-line side switching elements Q4-Q6.

Next, operation in the hammer 1 according to the one embodiment of the present invention will be described. As illustrated in FIG. 3(A), when the end bit 3 is pressed against a workpiece 4 in a state where the handle portion 10 is grasped by user's hand, both the impact member 42 and the intermediate member 44 are retracted rearward. By the retraction, the breathing holes 40a is closed by the impact member 42 and thus the air chamber 43 is hermetically sealed. Subsequently, when the trigger 13 is pulled for supplying the driving power to the brushless motor 21, the brushless motor 21 is rotationally driven. This rotational driving force is transmitted via both the pinion gear 23 and the first gear 34 to the crank shaft 33. Rotation of the crank shaft 33 is converted into reciprocating motion of the piston 41 disposed in the cylinder 40 by the motion converting mechanism 35 (the crank weight 36, the crank pin 37 and the connection-rod 38).

The reciprocating motion of the piston 41 results in occurrence of fluctuation in pneumatic pressure inside the air chamber 43, and then reciprocating motion of the impact member 42 is started following the reciprocating motion of the piston 41 due to an air spring action in the air chamber 43. The reciprocation motion of the impact member 42 causes collision of the impact member 42 against the intermediate member 44, so that impact force is transmitted to the end bit 3. Accordingly, the workpiece 4 can be crushed. More specifically, as illustrated in FIGS. 3(B) to 3(D), crack 5 is generated in the workpiece 4 because of impacting action by the end bit 3. In a period of time from a state illustrated in FIG. 3(B) to a state illustrated in FIG. 3(D), larger impact force is required for the generation of crack 5 in the workpiece 4. Subsequently, as illustrated FIGS. 3(E) to 3(H), the tip end portion of the end bit 3 moves into the inside of the crack 5 to enlarge the crack 5, and then the workpiece 4 is crushed. Impact force required in the time period from the state illustrated in FIG. 3(E) to the state illustrated in FIG. 3(H) is smaller than the impact force required in the time period from the state in FIGS. 3(B) to 3(D), since impact force required for enlargement of the crack 5 can be smaller than the impact force required for generation of the crack 5.

Current flowing through the brushless motor 21 and detected by the current detecting circuit 71 pulsates as indicated in FIG. 5(B). In detail, when the piston 41 and the impact member 42 become closest to each other, the current becomes a peak value and the rotational number indicated in FIG. 5(D) decreases (time t2). When the piston 41 and the impact member 42 become farthest from each other, the current decreases and the rotational number increases (time t3). Then, the intermediate member 44 impacted by the impact member 42 impacts the end bit 3, thereby transmitting impact force to the end bit 3 (time t4) as illustrated in FIG. 5(A).

Vibration having a substantially constant cycle is generated at the hammer 1 due to the reciprocating motion of the impact member 42 during the operation of the hammer 1, and thus the vibration is transmitted to both the leaf spring 61 and the counter weight 62 via the outer frame 30 and the motor housing 20. The vibration causes both the leaf spring 61 and the counter weight 62 to vibrate in a direction the same as a reciprocating direction of the piston 41. By the vibrations of the leaf spring 61 and the counter weight 62, the vibration generated at the hammer 1 due to the impacting operation can be reduced, and therefore enhanced operability of the hammer 1 can be obtained.

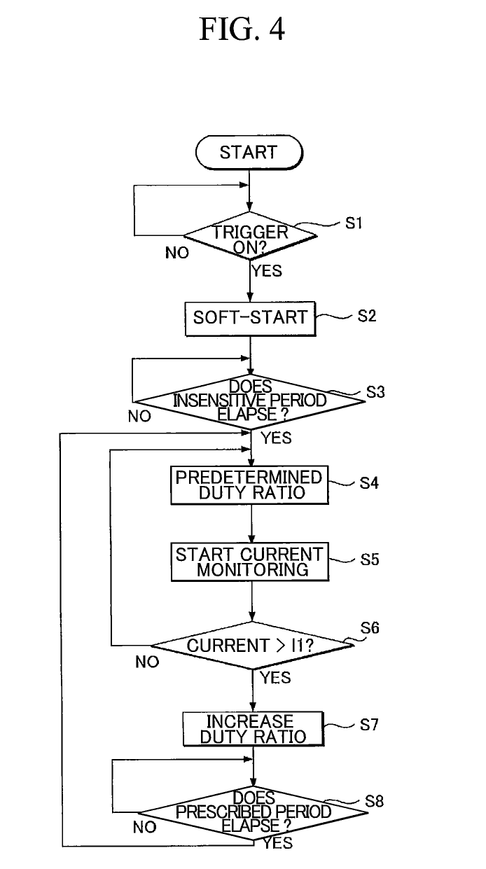

Next, the control to the hammer 1 will be described while referring to the flowchart illustrated in FIG. 4 and the graph shown in FIG. 5. In S1, if the trigger 13 is pulled (S1: Yes), the switch manipulation detecting circuit 72 detects that the trigger 13 is manipulated, and then outputs a signal to the arithmetic section 76. On the basis of the signal, the arithmetic section 76 starts a soft-start control (S2). The soft-start control means a control such that a duty ratio of the PWM signals is gradually increased during initial start-up period of driving the brushless motor 21 as indicated in FIG. 5(C). With the soft-start control, the rotational number indicated in FIG. 5(D) gently increases, and thus the impact force indicated in FIG. 5(A) gently increases. Further, by the soft-start control, a starting current indicated in FIG. 5(B) can be suppressed smaller. With such control, displacement of the end bit 3 relative to the workpiece 4 and breakage (such as chipping or cracks) can be prevented, and crushing work efficiency by the hammer 1 can be improved. A period of the soft-start control (a time period from a time at which the trigger 13 is pulled to time t1) is defined as an insensitive period of time. The insensitive period of time is an example of claimed “a low-speed control” of the present invention, and a period of time other than the insensitive period of time is an example of claimed “a high-speed control” of the present invention.

The duty ratio of the PWM driving signals indicated in FIG. 5(C) reaches a predetermined duty ratio at time t1. In the present embodiment, the predetermined duty ratio is 80%. The timer 76B of the arithmetic section 76 commences counting in response to pulling operation of the trigger 13. The arithmetic section 76 determines whether the insensitive period of time elapses on the basis of the signal outputted from the timer 76B (S3). If the insensitive period of time does not elapses (S3: No), the arithmetic section 76 waits for elapsing of the insensitive period of time. On the other hand, if the insensitive period of time elapses (S3: Yes), the brushless motor 21 is driven at the predetermined duty ratio (80%) in S4. Subsequently, the arithmetic section 76 monitors the current flowing through the brushless motor 21 on the basis of the signal outputted from the current detecting circuit 71 (S5). More specifically, the arithmetic section 76 determines whether the current flowing through the brushless motor 21 exceeds the current threshold value I1 stored in the storage section 76A (S6). If the current flowing through the brushless motor 21 does not exceed the current threshold value I1 (S6: No), the routine returns to S4. On the other hand, if the current flowing through the brushless motor 21 exceeds the current threshold value I1 (S6: Yes), determination is made that a load imposed on the brushless motor 21 exceeds a prescribed value. Then, the control-signal outputting circuit 77 increases the duty ratio of the PWM driving signals on the basis of the signal outputted from the arithmetic section 76. In the present embodiment, the PWM driving signals are increased to 99% (S7). In detail, the arithmetic section 76 detects that the current exceeds the current threshold value I1 at time t5, and then increases the duty ratio of the PWM drive signals at time t6. A time lag from time t5 to time t6 is provided for increasing impact force of an impacting action D2 performed subsequent to an impacting action D1 at which the current exceeding the current threshold value I1 is detected. The arithmetic section 76 increases the duty ratio of the PWM drive signals during a period of time from time t6 to time t7 (hereinafter simply referred to as “prescribed period”). In present embodiment, the increased ratio of the PWM signals is maintained only during approximately one-thirtieth of a second, which corresponds to a period of time required for a single impacting action. In other words, the driving power supplied to the brushless motor 21 is increased only during approximately one-thirtieth of a second. By this control, the impact force of the impacting action D2 which is performed following the impacting action D1 at which the current exceeding the current threshold value I1 is detected is increased as indicated in FIG. 5(A).

The arithmetic section 76 determines whether the prescribed period elapses on the basis of the signal from the timer 76B (S8). If the prescribed period does not elapse (S8: No), the duty ratio of the PWM signals is maintained at 99%. On the other hand, if the prescribed period elapses (S8: Yes), the duty ratio of the PWM signals is changed to the predetermined duty ratio (S4). The above processings S4 to S8 are repeatedly performed until the trigger 13 is released from being pulled. Incidentally, if the trigger 13 is released, the driving power supply to the brushless motor 21 is stopped, although not illustrated in FIG. 4. As described above, the arithmetic section 76 is adapted to perform control such that the driving power is restored to ordinary driving power after being increased during the prescribed period.

As indicated in FIG. 5(B), if the current again exceeds the current threshold value I1 at time t8 (S6: Yes), the arithmetic section 76 increases the duty ratio at time t9 (S7) so as to increase an impact force of an impacting action D3. Then, at time t10, the duty ratio becomes at the predetermined duty ratio (S8: Yes), so that an impacting action D4 is performed at ordinary impact force. However, because the current remains larger than the current threshold value I1 at time t11 (S6: Yes), the arithmetic section 76 again increases the duty ratio at time t12 (S7) in order to obtain larger impact force of an impacting action D5. That is, in the first embodiment, the arithmetic section 76 increases the driving power supplied to the brushless motor 21 after the current exceeds the current threshold value I1 in order to increase impact force of a single impacting action to be performed immediately after the current exceeds the current threshold value I1.

In the above configuration, the driving power is increased for only one impacting action. Therefore, at time t11 after increasing the driving power, determination can be made as to whether there is a necessity to increase the duty ratio for the next impacting action. Consequently, the driving power can be increased only when large load is imposed on the brushless motor 21.

By the above configuration, if large impact force is required for crushing the workpiece 4 as indicated FIGS. 3(A) to 3(D), the impact force of the end bit 3 can be automatically increased in response to the load imposed on the brushless motor 21 (S6). Further, if the large impact force is not required such as after the generation of the crack 5 indicated in FIG. 3(E) to 3(H), the impact force of the end bit 3 can be automatically returned to ordinary impact force (S8: Yes).

According to the above-described configuration, constant supply of the large driving power to the hammer 1 is not required. Instead, the large driving power is supplied to the hammer 1 only in case of large load application to the hammer. Thus, the number of times of the impacting action with large impact force can be reduced. Therefore, durability of mechanical parts, those being components of the motion converting mechanism 35 and the bit holding portion 15, can be improved. Further, in a state where low load is imparted, noise and vibration can be reduced because the impact force is small. Particularly in a no-load state, remarkable reduction effect in vibration and noise can be obtained.

Further, with the above configuration, the driving power can be increased by increasing the duty ratio of the PWM drive signals outputted from the control portion 24 to the inverter circuit board 25.

Further, in the above configuration, detection of the load can be performed on the basis of the current flowing through the brushless motor 21. Therefore, the driving power can be adjusted in response to the load. Consequently, prolonged service life of the parts and components employed in the hammer 1 can be obtained, and reduction in vibration and noise can be realized.

In the above configuration, the soft-start control is performed immediately after start-up of driving the brushless motor 21. Therefore, positioning of the crushing point can be facilitated. Consequently, the operability of the hammer 1 can be improved, and thus enhanced work efficiency can be obtained.

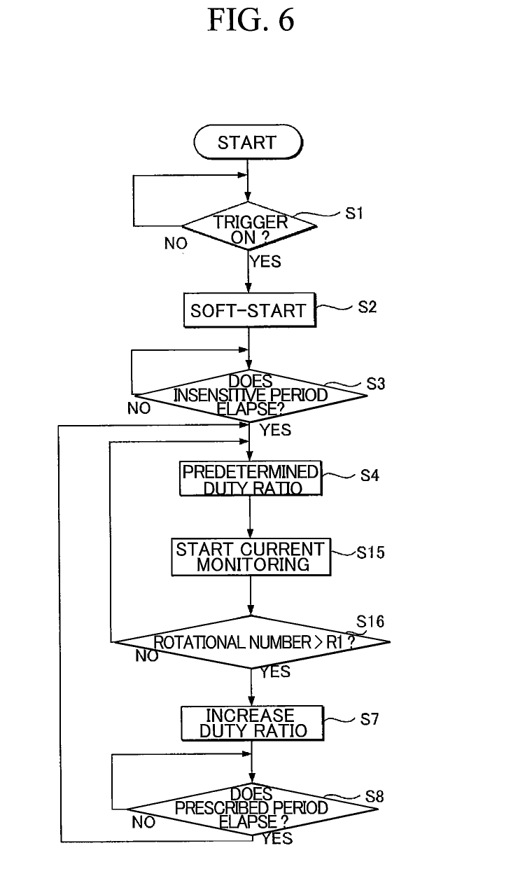

Next, a second embodiment of the present invention will be described while referring to FIGS. 5 and 6. The same components as those of the first embodiment are represented by the same reference numerals, and the explanation regarding the same components will be omitted. In the first embodiment, if the current flowing through the brushless motor 21 exceeds the current threshold value I1, the arithmetic section 76 is adapted to determine that a load imposed on the brushless motor 21 exceeds a prescribed value. In contrast, in the second embodiment, if the rotational number of the brushless motor 21 is not more than a rotational number threshold value R1, the arithmetic section 76 is adapted to determine that the load imposed on the brushless motor 21 exceeds the prescribed value.

The rotational number threshold value R1 is provisionally stored in the storage section 76A of the arithmetic section 76. The arithmetic section 76 monitors the rotational number of the brushless motor 21 on the basis of the signal outputted from the rotational number detecting circuit 75 (S15). At time t5 indicated in FIG. 5(D), if the rotational number of the brushless motor 21 is lower than the rotational number threshold value R1 (S16: Yes), determination is made that the load imposed on the brushless motor 21 exceeds the prescribed value. At this time, the duty ratio is increased to 99% during the prescribed period (S7). Similarly, at time t8, and time t11, determination is made that the load imposed on the brushless motor 21 exceeds the prescribed value, and the duty ratio is again increased to 99% during the prescribed period (S7).

In the above configuration, the load can be detected on the basis of the rotational number of the brushless motor 21. Therefore, the driving power can be adjusted in response to the load. Consequently prolonged service life of the parts and components can be obtained, and reduction in vibration and noise can be realized.

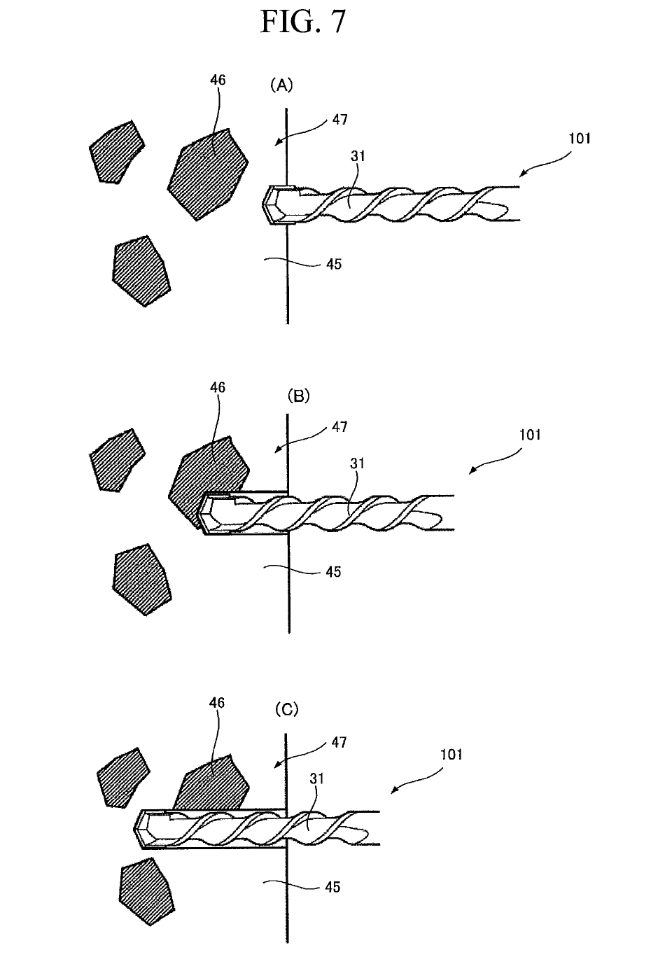

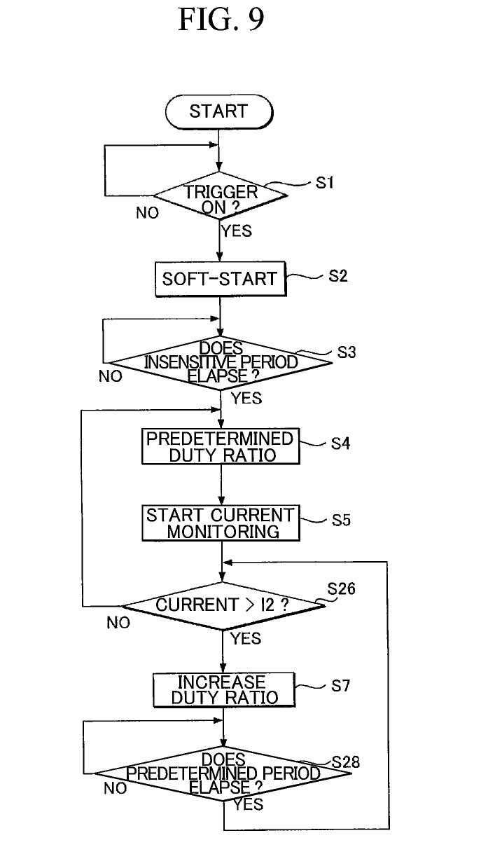

Next, a third embodiment of the present invention will be described while referring to FIGS. 7 to 9. The same components as those of the above embodiments are represented by the same reference numerals, and the explanation regarding the same components will be omitted. In the third embodiment, a hammer drill 201 is an example of the impact tool according to the present invention. In the hammer drill 201 equipped with an end bit 31 (FIG. 7), the end bit 31 is applied with a rotational force in addition to the impact force.

As illustrated in FIG. 7, the end bit 31 is configured to drill a workpiece 47 with the rotational force and the impact force. The workpiece 47 is constituted of a concrete 45 and a stone 46 whose hardness is higher than that of the concrete 45. In drilling the workpiece 47, when a distal end of the end bit 31 is in abutment with the stone 46 as indicated in FIG. 7(B), large impact force and large rotational force are required until the stone 46 is crushed as indicated in FIG. 7(C). In the third embodiment, a driving power supplied to the brushless motor 21 is adapted to be increased while a large load is imposed on the brushless motor 21, and therefore, efficient drilling operation can be implemented.

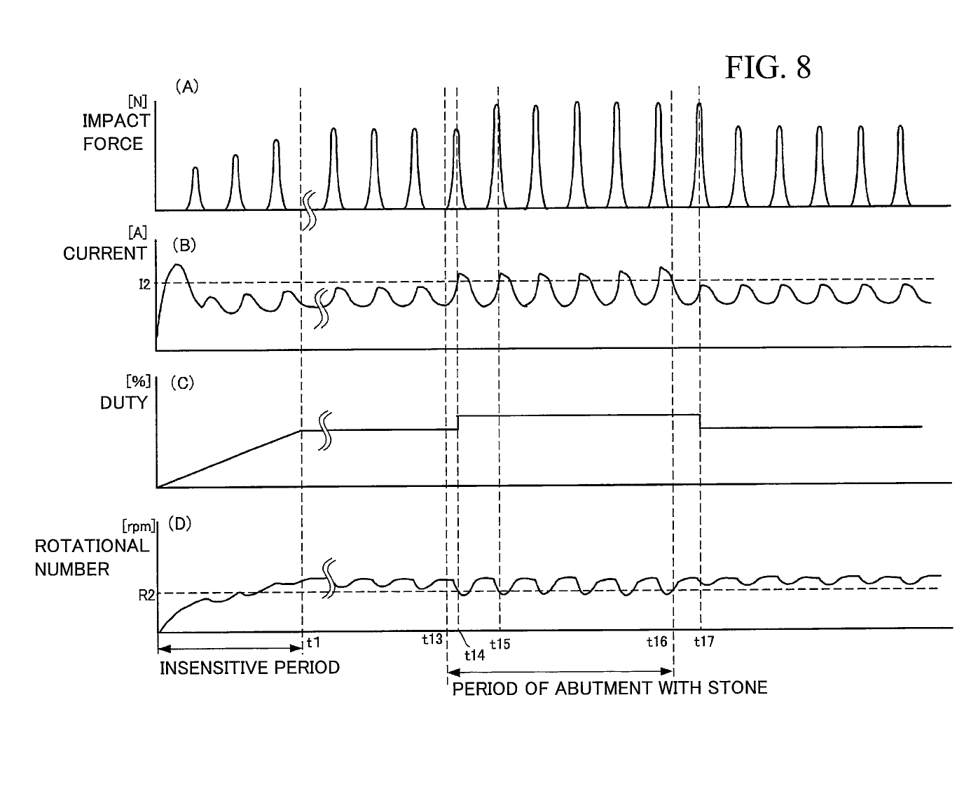

The arithmetic section 76 has the storage section 76A provisionally storing a current threshold value I2. As illustrated in FIG. 8, the end bit 31 is in abutment with the stone 46 during a time period from time t13 to time t16. Upon abutment of the end bit 31 with stone 46 at time t13, a load imposed on the brushless motor 21 increases. By this increase of the load, a peak of a current exceeds the current threshold value I2 (S26: Yes). When the current exceeds the current threshold value I2 at time t14, determination is made that the load imposed on the brushless motor 21 exceeds the prescribed value, and then the duty ratio is increased to 99% (S7).

A time period from time t14 to time t15 (hereinafter simply referred to as “predetermined period”) is measured by the timer 76B. The predetermined period is approximately the same as a cycle to the current. At time t15, determination is again made as to whether the current is greater than the current threshold value I2 (S26). If the current is greater than the current threshold value I2 (S26: Yes), the duty ratio is maintained at 99% (S7). As indicated in FIG. 7(C), the duty ratio is continuously maintained at 99% until the stone is crushed. After the stone 46 is crushed at time t16, the peak of the current becomes not more than the current threshold value I2. That is, at time t17 when the predetermined period elapses from time t16 (S28: Yes), the duty ratio is changed to the predetermined duty ratio (S4) because determination is made that the current is not more than the current threshold value I2 (S26: No). In other words, in the third embodiment, a time period from time t14 to time t16 is an example of claimed “a prescribed period” of the present invention. In this way, the arithmetic section 76 is adapted to control to increase the driving power supplied to the brushless motor 21 while a load detected by a load detecting portion exceeds the prescribed value.

According to the above-described configuration, a driving power greater than ordinary driving power is supplied to the brushless motor 21 while a large load is imposed thereon. Thus, large impact force can be obtained. Consequently, ensured crushing of stones and some other workpiece requiring higher impact force can be realized.

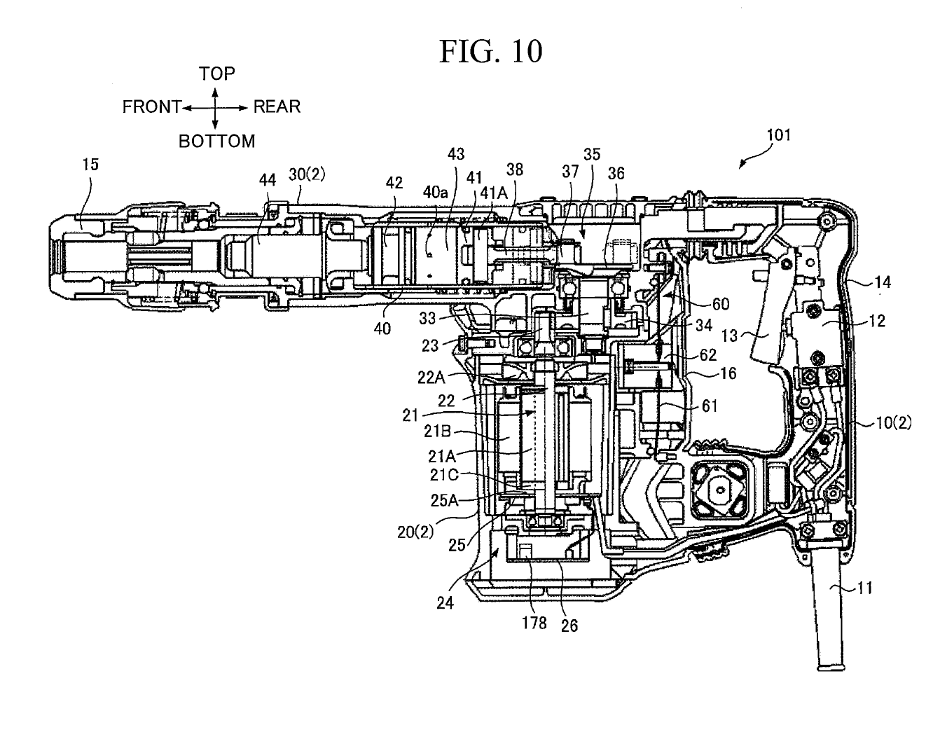

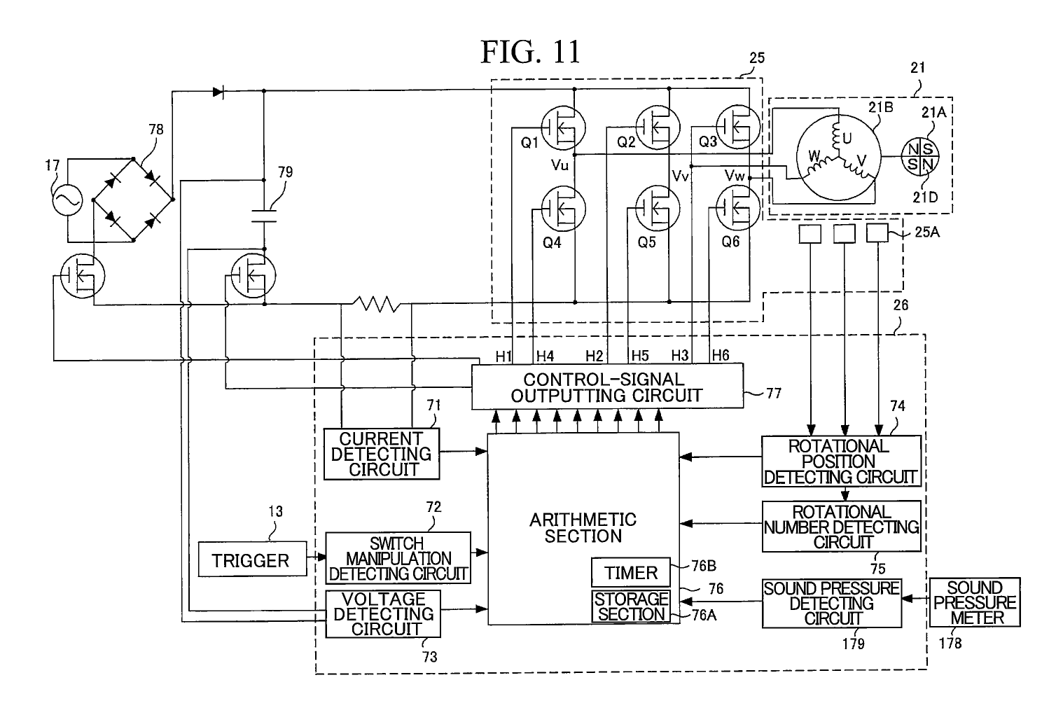

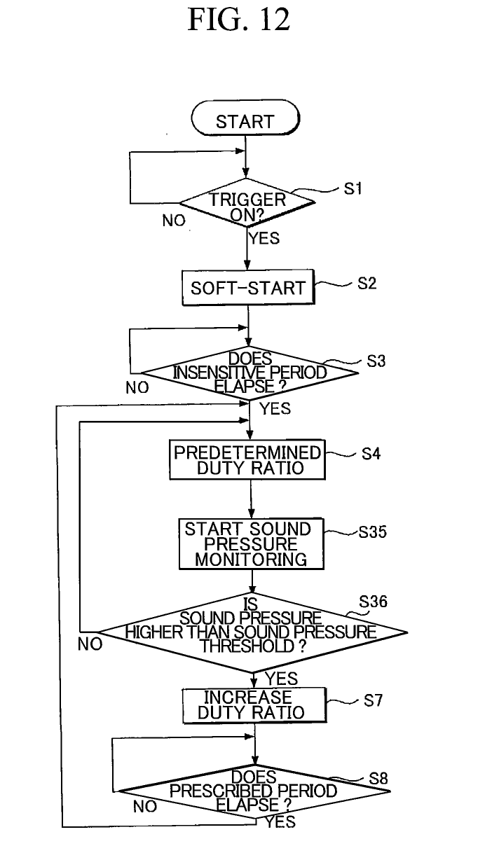

Next, the fourth embodiment will be described while referring to FIGS. 10 to 12. Like parts and components are designated by the same reference numerals as those shown in the foregoing embodiments to avoid duplicating description.

A drilling tool 201 includes the control board 26 having a sound pressure meter 178 adapted to detect ambient sound pressure (FIG. 10). The control board 26 further has a sound pressure detecting circuit 179 connected to the sound pressure meter 178. The sound pressure detecting circuit 179 is adapted to output a signal indicative of the detected sound pressure to the arithmetic section 76 on the basis of an output from the sound pressure meter 178. The sound pressure detecting circuit 179 is an example of claimed “a load detecting portion” of the present invention, and is also an example of claimed “a sound pressure detecting portion” of the present invention.

As indicated in FIGS. 3(A) to 3(D), loud impact noise is generated upon impacting the workpiece 4 by the end bit 3 if large impact force is required (when large load is imposed on the brushless motor 21). On the other hand, as indicated in FIGS. 3(E) to 3(H), low impact noise is generated by the end bit 3 impacting the workpiece 4 if the large impact force is not required (when small load is imposed on the brushless motor 21). In the fourth embodiment, the load imposed on the brushless motor 21 is determined on the basis of the sound pressure detected by the sound pressure meter 178.

The arithmetic section 76 drives the brushless motor 21 at the predetermined duty ratio and starts monitoring the sound pressure (S35) after the trigger is manipulated (S1: Yes). The arithmetic section 76 determines whether the signal outputted from the sound pressure detecting circuit 179 is higher than a sound pressure threshold stored in the storage section 76A (S36). If the detected sound pressure is higher than the sound pressure threshold (S36: Yes), the arithmetic section 76 increases the duty ratio to 99%.

In the above configuration, on the basis of the impact noises generated at the impacting action or during the drilling operation, the load imposed on the brushless motor 21 can be detected. Therefore, the driving power can be adjusted in response to the load. Consequently prolonged service life of the parts and components employed in the drilling tool 201 can be obtained, and reduction in vibration and noise can be realized.

The impact tool according to the present invention is not limited to the above-described embodiments, and various changes and modifications may be made without departing from the scope of the invention.

In the above-described embodiments, the predetermined duty ratio is 80% and the control is performed such that the duty ratio is increased to 99% in response to the load imposed on the brushless motor 21. However, the invention is not limited to this configuration. For example, the predetermined duty ratio can be set to 90%, and the duty ratio can be increased to 100%.

In the above-described embodiments, determination is made that the load imposed on the brushless moto 21 is increased when any one of the current, the rotational number, and the sound pressure exceeds the predetermined threshold level. However, the invention is not limited to this configuration. For example, determination is made that the load imposed on the brushless moto 21 is increased when at least one of the current, the rotational number, and the sound pressure exceeds the predetermined threshold level. According to the latter, the load imposed on the brushless motor 21 can be determined on the basis of a plurality of parameters, and therefore improved determination accuracy can be realized.

In the first embodiment, when the current exceeds the current threshold value I1, the duty ratio is increased only during the subsequent single impacting action which is performed immediately after the current exceeds the current threshold value I1 (approximately for one-thirtieth of a second), that is the example of claimed “prescribed period” of the present invention. However, the invention is not limited to this. For example, the prescribed period can be more prolonged to two successive impacting actions immediately after the current exceeds the current threshold value I1 (approximately for one-fifteenth of a second), or can be prolonged longer than the above described period. Also, the increased duty ratio can be restored to the predetermined duty ratio by detecting a lower limit of the current, that is, the current at time t3.

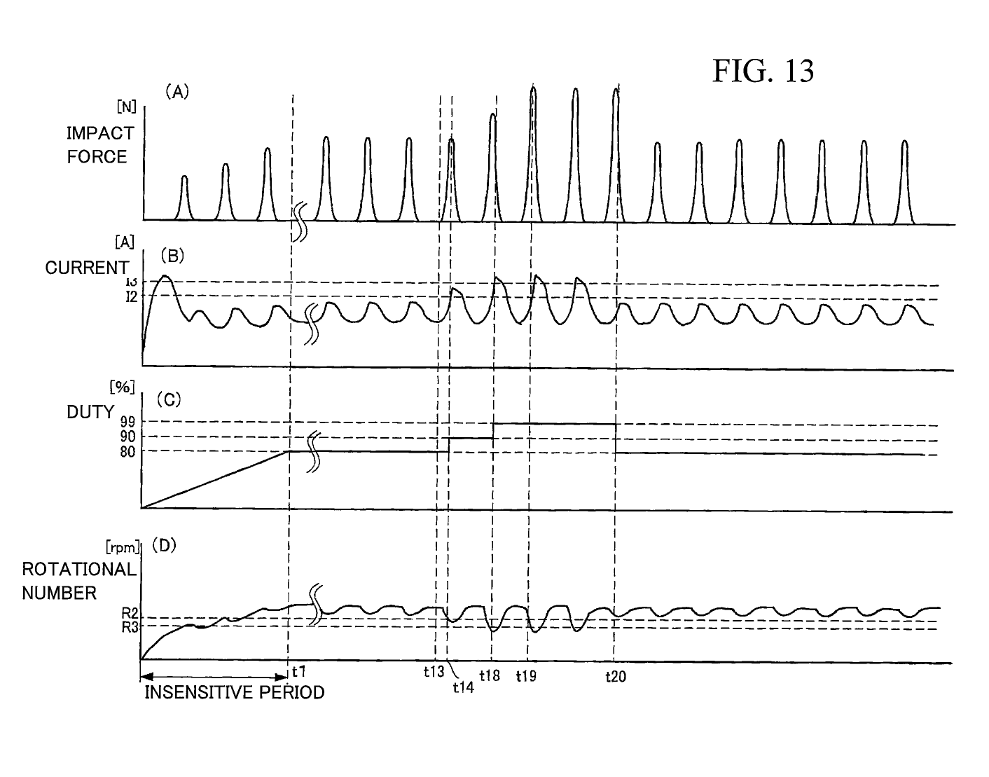

In the above embodiments, the duty ratio is increased from 80% to 99% when the current exceeds a single current threshold value (for example, I1 or I2). However, the invention is not limited to this control. For example, the duty ratio may be increased in stepwise fashion on the basis of two current threshold values. More specifically, not only the current threshold value I2 but also a current threshold value I3 greater than the current threshold value I2 are stored in the storage section 76A. When the current detected by the current detecting circuit 71 exceeds the current threshold value I2 but is lower than the current threshold value I3 as indicated in FIG. 13(B) (time t14), the duty ratio is increased to 90% as indicated in FIG. 13(C). The duty ratio is then increased to 99% when the current exceeds the current threshold value I3 at time t18 t. When the current becomes lower than the current threshold 12 at time t20, the duty ratio is returned to the predetermined duty ratio of 80%. Consequently, the workpiece can be impacted by appropriate impact force in response to fluctuation of the load imposed on the brushless motor 21. Similarly, stepwise increase in duty ratio can be performed on a basis of two rotational number thresholds. Specifically, the rotational number threshold value R2 and a rotational number threshold value R3 lower than the rotational number threshold value R2 are stored in the storage section 76A. The duty ratio is increased to 90% as indicated in FIG. 13(C) when the rotational number detected by the rotational number detecting circuit 75 is lower than the rotational number threshold value R2 but is greater than the rotational number threshold value R3 as indicated in FIG. 13(D) (time t14). Then, the duty ratio is increased to 99%, when the rotational number becomes lower than the rotational number threshold value R3 at time t18 t. As another modification, not less than three threshold values can be used. As still another modification, both the current and the rotational number may be monitored, so that the duty ratio may be increased when the current exceeds the current threshold value and the rotational number is lower than the rotational number threshold value. Similarly, two sound pressure thresholds may be provided, and alternatively, the load imposed on the brushless motor 21 may be determined on the basis of at least one of the sound pressure, the current, and the rotational number.

In above embodiments, the hammer and the hammer drill are employed as examples of the impact tool. but tools other than hammer and hammer drill are also available.

### REFERENCE SINGS LIST

1, 101: hammer, 2: housing, 3: end bit, 4: workpiece, 11: power cable, 15: end bit holding portion, 21: brushless motor, 24: control portion, 25: inverter circuit board, I1, I2, I3: current threshold value, R1, R2, R3: rotational number threshold value:

1. An impact tool comprising:
a housing;
a motor disposed in the housing;
a motion converting portion configured to convert a rotating motion of the motor into a reciprocating motion;
an output portion configured to output the reciprocating motion of the motion converting portion as an impact force;
a power supply portion configured to supply a driving power to the motor;
a load detecting portion configured to detect a load imposed on the motor; and
a control portion configured to control the power supply portion to increase the driving power supplied to the motor during a prescribed period when the load detected by the load detecting portion is larger than a prescribed value.

2. The impact tool according to claim 1, wherein the prescribed period is a time period during which at least a single impacting action is performed.

3. The impact tool according to claim 1, wherein the control portion is configured to restore the driving power supplied to the motor to an ordinary driving power after increasing the driving power supplied to the motor for the prescribed period.

4. The impact tool according to claim 1, wherein the power supply portion comprises an inverter circuit board, the control portion being configured to increase the driving power by increasing a duty ratio of a PWM outputted to the inverter circuit board.

5. The impact tool according to claim 1, wherein the load detecting portion comprises a current detecting portion configured to detect a current flowing through the motor, the control portion being configured to control the power supply portion to increase the driving power supplied to the motor during the prescribed period when the current detected by the current detecting portion is greater than a current threshold level.

6. The impact tool according to claim 1, wherein the load detecting portion comprises a rotational number detecting portion configured to detect a rotational number of the motor, the control portion being configured to control the power supply portion to increase the driving power supplied to the motor during the prescribed period when the rotational number detected by the rotational number detecting portion is not more than a rotational number threshold level.

7. The impact tool according to claim 1, wherein the load detecting portion comprises a sound pressure detecting portion configured to detect a sound pressure, the control portion being configured to control the power supply portion to increase the driving power supplied to the motor during the prescribed period when the sound pressure detected by the sound pressure detecting portion is higher than a sound pressure threshold level.

8. The impact tool according to claim 1, wherein the control portion is configured to control the power supply portion to increase the driving power supplied to the motor while the load detected by the load detecting portion exceeds the prescribed value.

9. The impact tool according to claim 1, wherein the control portion is configured to control the power supply portion to further increase the driving power supplied to the motor when the load detected by the load detecting portion further exceeds a threshold value larger than the prescribed value after the load exceeds the prescribed value.

10. The impact tool according to claim 1, wherein the control portion is configured to perform a low-speed control immediately after start-up period of the motor, and to perform a high-speed control in response to the load detected by the load detecting portion.
